(19) United States
(12) Patent Application Publication
(10) Pub. No.: US 2004/0005991 A1
(43) Pub. Date: Jan. 8, 2004

(54) Hand dishwashing composition containing a suds suppresser and a method of use therefor

(75) Inventors: Jeffrey Edward Boucher, Beijing (CN); Drakon Li, Beijing (CN)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/447,121

(22) Filed: May 28, 2003

(30) Foreign Application Priority Data
Nov. 29, 2000 (WO) PCT/US00/32532

(51) Int. Cl. C11D 17/00

(52) U.S. Cl. 510/235; 510/218; 510/426

(57) ABSTRACT

A hand dishwashing composition includes from 0.1% to 90% of a sudsing surfactant, an effective amount of a suds suppresser, and the balance adjunct ingredients. A method for reducing the amount of water used during the rinsing step of a hand dishwashing process includes the steps of providing the hand dishwashing composition described herein, applying it to a dish and washware, wherein after the application step the dish comprises suds thereupon, and rinsing the suds from the dish with water.

### CROSS REFERENCES TO RELATED APPLICATIONS

This application claims the benefit of the filing date of PCT application No. U.S. 01/44561 filed Nov. 28, 2001, which claims the benefit of the filing date of PCT application No. U.S. 00/32532 filed Nov. 29, 2000, which are incorporated by reference herein.

### FIELD OF THE INVENTION

The present invention relates to a cleaning composition suitable for use in hand dishwashing, and a method for reducing water use.

### BACKGROUND OF THE INVENTION

Hand dishwashing compositions are well known in the art. They may come in the form of a pastes, a gel, a block, etc., but are most commonly in the form of a liquid. Such products are formulated to provide a number of performance and aesthetics properties. The majority of the cleaning performance is generally provided by surfactants that provide acceptable solubilization and removal of food soils, especially greasy soils, from dishware being cleaned with, or in aqueous solutions formed from such products.

Typically, the hand dishwashing formulator has been concerned with increasing the amount, stability, and volume of suds formed while the product is used. This is because many consumers feel that such suds are an indicator of how effective the dishwashing composition is, and an indicator of whether the level of dishwashing composition is sufficient. However, it has now been found that such high-sudsing products are deemed undesirable by certain consumers, especially those who may believe that long lasting and voluminous suds are an indication of excessive surfactant residue. Furthermore, in areas where water is scarce and/or expensive, it is desirable to reduce the amount of rinsing required to remove suds from, for example, a dish and/or washware. In fact, it has now been found that some consumers spend significant amounts of water rinsing suds from washware. Such consumers, herein referred to as “suds-sensitive consumers”, may still desire compositions which form suds during use, and yet whose suds are rapidly dispersed, less stable, and/or which are lower in volume.

While a low-sudsing composition may be provided by decreasing the surfactant, this adversely affects the composition's cleaning performance, and significantly decreases the grease cleaning ability. This solution is unacceptable to suds-sensitive consumers who still desire high cleaning performance.

Accordingly, the need exists for a liquid cleaning composition having a reduced sudsing profile, and yet which still provides acceptable cleaning performance. Furthermore, the need exists for a method for reducing the amount of water used in the rinsing step of a hand dishwashing process.

### SUMMARY OF THE INVENTION

The present invention relates to a hand dishwashing composition which includes from 0.1% to 90% of a sudsing surfactant, an effective amount of a suds suppresser, and the balance adjunct ingredients. The present invention also relates to a method for reducing the amount of water used during the rinsing step of a hand dishwashing process which includes the steps of providing the hand dishwashing composition described herein, applying it to a dish and washware, wherein after the application step the dish and washware comprise suds thereupon, and rinsing the suds from the dish and washware with water.

Surprisingly, a suds suppresser, and especially a silicone-based suds suppresser can significantly reduce the sudsing profile by reducing the surface tension of the air-water interface. This decreases the sudsing profile of the hand dishwashing composition. Surprisingly, however, the suds suppresser useful herein does not reduce the effectiveness of the surfactant, at the oil-water interface, and therefore does not negatively impact the cleaning and/or grease-solubilizing ability of the surfactant. Such a composition thus solves the paradox by providing a reduced sudsing profile to suds-sensitive consumers, significantly reducing the amount of water used for rinsing, and still provides acceptable cleaning and/or grease-solubilizing performance. The present invention also surprisingly provides an improved solution feel during washing, and can enhance the “squeaky-clean” feel and sound desired by many consumers when washing ceramics, plastics, etc. By employing the composition of the present invention and the method herein, the consumer may significantly reduce the amount of water used during the rinsing step of a hand dishwashing process.

### DETAILED DESCRIPTION OF THE INVENTION

All percentages, ratios and proportions herein are by weight of the hand dishwashing composition, unless otherwise specified. All temperatures are in degrees Celsius (° C.) unless otherwise specified. All documents cited are incorporated herein by reference in their entireties. Citation of any reference is not an admission regarding any determination as to its availability as prior art to the claimed invention.

As used herein, the term “alkyl” means a hydrocarbyl moiety which is straight, cyclic or branched, saturated or unsaturated. Unless otherwise specified, alkyl moieties are preferably saturated or unsaturated with double bonds, preferably with one or two double bonds. Included in the term “alkyl” is the alkyl portion of acyl groups.

As used herein, the term “dish” means any dishware, tableware, cookware, glassware, etc. which is washed prior to, or after contacting food and/or being used in a food preparation process.

As used herein, the term “washware” means any dishwashing basin, sink, washing implements (such as brushes, wash cloths, scouring pads, sponges,), etc. which are used to wash a dish, and which accumulate suds which are typically rinsed off.

As used herein, unless otherwise specifically otherwise defined, the term “effective amount” means that the formulator of the composition can select an amount of the compound to be incorporated into the compositions that will improve the cleaning, aesthetics, performance, etc. of the composition.

As used herein, the term “rinsing” includes rinsing suds from any article used in the hand dishwashing process, and especially from a dish, or washware.

As used herein, the term “sudsing profile” means the physical characteristics of the suds formed, as perceived by a typical consumer, during use of the composition for hand washing a dish. Specifically, this term refers to both the amount/volume of suds formed and the longevity/resiliency of the suds formed.

### Sudsing Surfactant

The sudsing surfactant useful herein is a surfactant which forms suds having a unacceptable sudsing profile, and specifically, a sudsing profile in which the suds during use are very long lasting, and resilient. Thus, the sudsing surfactant typically has a sudsing profile of at least about 5 cm, more typically at least about 8 cm, as measured by the method, below, when the suds suppresser is absent. More specifically, the sudsing surfactant is typically selected from an anionic surfactant, a nonionic surfactant, an amphoteric surfactant, or a mixture thereof, and more preferably an alkyl ethoxylate sulfate surfactant, an alkoxylated nonionic surfactant, an amine oxide surfactant, or a mixture thereof. Especially useful herein is a combination of anionic surfactant and an nonionic surfactant which forms a sudsing surfactant system

The anionic surfactant useful herein includes water-soluble salts or acids of the formula ROSO₃M, wherein R preferably is a C₆-C₂₀ linear or branched hydrocarbyl, preferably an alkyl or hydroxyalkyl having a C₁₀-C₂₀ alkyl component, more preferably a C₁₀-C₁₄ alkyl or hydroxyalkyl, and M is H or a cation, e.g., an alkali metal cation or ammonium or substituted ammonium, but preferably sodium and/or potassium.

Other suitable anionic surfactants for use herein are water-soluble salts or acids of the formula RO(A)ₘSO3M wherein R is an unsubstituted linear or branched C₆-C₂₀ alkyl or hydroxyalkyl group having a C₁₀-C₂₀ alkyl component, preferably a C₁₂-C₂₀ alkyl or hydroxyalkyl, more preferably C₁₂-C₁₄ alkyl or hydroxyalkyl, A is an ethoxy or propoxy unit, m is greater than zero, typically between about 0.5 and about 5, more preferably between about 0.5 and about 2, and M is H or a cation which can be, for example, a metal cation, ammonium or substituted-ammonium cation. Alkyl ethoxylated sulfates (abbreviated herein as C_{X-Y}EₘS, where X-Y represents the alkyl group chain length, and where m is the same as described above) as well as alkyl propoxylated sulfates are thus preferred herein. Exemplary surfactants are C₁₀-C₁₄ alkyl polyethoxylate (1.0) sulfate, C₁₀-C₁₄ polyethoxylate (1.0) sulfate, C₁₀-C₁₄ alkyl polyethoxylate (2.25) sulfate, C₁₀-C₁₄ polyethoxylate (2.25) sulfate, C₁₀-C₁₄ alkyl polyethoxylate (3.0) sulfate, C₁₀-C₁₄ polyethoxylate (3.0) sulfate, and C₁₀-C₁₄ alkyl polyethoxylate (4.0) sulfate, C₁₀-C₁₈ polyethoxylate (4.0) sulfate. In a preferred embodiment the anionic surfactant is a mixture of alkoxylated, preferably ethoxylated and non-alkoxylated sulfate surfactants. In such a preferred embodiment the average degree of alkoxylation is from about 0.4 to about 0.8.

Other particularly suitable anionic surfactants for use herein are alkyl sulphonates and alkyl aryl sulphonates, including water-soluble salts or acids of the formula RSO₃M wherein R is a C₆-C₂₀ linear or branched, saturated or unsaturated alkyl or aryl group, preferably a C₁₀-C₂₀ alkyl or aryl group and more preferably a C₁₀-C₁₄ alkyl or aryl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Also highly preferred are the linear and branched alkyl benzene sulphonates and more preferably linear alkyl benzene sulphonate.

In a further preferred embodiment, the carbon chain of the anionic surfactant comprises one or more alkyl, preferably C₁₋₄ alkyl, branching units. In such a case, the average percentage branching of the anionic surfactant is greater than about 30%, more preferably from about 35% to about 80% and most preferably from about 40% to about 60%. Such average percentage of branching can be achieved by formulating the composition with one or more anionic surfactants all of which are preferably greater than about 30% branched, more preferably from about 35% to about 80% and most preferably from about 40% to about 60%. Alternatively and more preferably, the composition may comprise a combination of branched anionic surfactant and linear anionic surfactants such that on average the percentage of branching of the total anionic surfactant combination is greater than about 30%, more preferably from about 35% to about 80% and most preferably from about 40% to about 60%.

A nonionic surfactant is also useful herein as a sudsing surfactant. Nonionic surfactants useful herein are generally disclosed in U.S. Pat. No. 3,929,678 to Laughlin, et al., issued Dec. 30, 1975, at column 13, line 14 through column 16, line 6. Other nonionic surfactants useful herein include the condensation products of aliphatic alcohols with from about 1 to about 25 moles of ethylene oxide. The alkyl chain of the aliphatic alcohol can either be straight or branched, primary or secondary, and generally contains from about 8 to about 22 carbon atoms. Particularly preferred are the condensation products of alcohols having an alkyl group containing from about 10 to about 20 carbon atoms with from about 2 to about 18 moles of ethylene oxide per mole of alcohol. Examples of commercially available nonionic surfactants of this type include TERGITOL® 15-S-9 (the condensation product of C₁₁-C₁₅ linear secondary alcohol with 9 moles ethylene oxide), TERGITOL® 24-L-6 NMW (the condensation product of C₁₂-C₁₄ primary alcohol with 6 moles ethylene oxide with a narrow molecular weight distribution), both marketed by Union Carbide Corporation; NEODOL® 45-9 (the condensation product of C₁₄-C₁₅ linear alcohol with 9 moles of ethylene oxide), NEODOL® 23-6.5 (the condensation product of C₁₂-C₁₃ linear alcohol with 6.5 moles of ethylene oxide), NEODOL® 45-7 (the condensation product of C₁₄-C₁₅ linear alcohol with 7 moles of ethylene oxide), NEODOL® 45-4 (the condensation product of C₁₄-C₁₅ linear alcohol with 4 moles of ethylene oxide), marketed by Shell Chemical Company, and KYRO® EOB (the condensation product of C₁₃-C₁₅ alcohol with 9 moles ethylene oxide), marketed by The Procter & Gamble Company, Cincinnati, Ohio, U.S.A. Other commercially available nonionic surfactants include DOBANOL 91-8® marketed by Shell Chemical Co. and GENAPOL UD-080® marketed by Hoechst. This category of nonionic surfactant is referred to generally as “alkyl ethoxylates.” Also useful herein is a nonionic surfactant selected from the group consisting of an alkyl polyglycoside surfactant, a fatty acid amide surfactant, a C₈-C₂₀ ammonia amide, a monoethanolamide, a diethanolamide, an isopropanolamide, and a mixture thereof. Such nonionic surfactants are known in the art, and are commercially-available.

The amphoteric surfactant herein is preferably selected from the various amine oxide surfactants. Amine oxides are semi-polar nonionic surfactants and include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Preferred amine oxide surfactants have the formula:

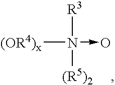

where R³ is an alkyl, a hydroxyalkyl, an alkyl phenyl group or a mixture thereof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or a hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure. Preferred amine oxide surfactants include the C₁₀-C₁₈ alkyl dimethyl amine oxides and the C₈-C₁₂ alkoxy ethyl dihydroxy ethyl amine oxides.

Also suitable are amine oxides such as propyl amine oxides, represented by the formula:

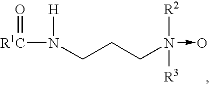

where R¹ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R² and R³ are each methyl, ethyl, propyl, isopropyl, 2-hydroxyethyl, 2-hydroxypropyl, or 3-hydroxypropyl and n is from 0 to about 10.

A further suitable species of amine oxide semi-polar surface active agents comprise compounds and mixtures of compounds having the formula:

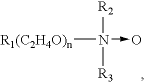

where R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10. Particularly preferred are amine oxides of the formula:

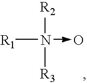

where R₁ is a C₁₀₋₁₄ alkyl and R₂ and R₃ are methyl or ethyl. Because they are low-foaming it may also be particularly desirable to use long chain amine oxide surfactants which are more fully described in U.S. Pat. No. 4,316,824 to Pancheri, granted on Feb. 23, 1982; U.S. Pat. No. 5,075,501 to Borland and Smith, granted on Dec. 24, 1991; and U.S. Pat. No. 5,071,594 to Borland and Smith, granted on Dec. 10, 1991.

Other suitable, non-limiting examples of the amphoteric surfactant useful herein includes amido propyl betaines and derivatives of aliphatic or heterocyclic secondary and ternary amines in which the aliphatic moiety can be straight chain, or branched and wherein one of the aliphatic substituents contains from about 8 to about 24 carbon atoms and at least one aliphatic substituent contains an anionic water-solubilizing group. Further examples of suitable amphoteric surfactants are disclosed in “Surface Active Agents and Detergents” (Vol. I and II by Schwartz, Perry and Berch).

Generally, the level of sudsing surfactant in the hand dishwashing composition herein is from about 0.1% to about 90%, preferably from about 5% to about 50%, and more preferably from about 10% to about 40%, by weight. An alkoxylated anionic surfactant comprising on average less than about 4 moles of alkoxy groups is preferably at least about 10%, more preferably from about 15% to about 40% and most preferably from about 20% to about 35% by weight of the total composition. The anionic surfactant comprising on average at least about 4 moles of alkoxy groups is preferably at least about 20%, more preferably from about 25% to about 35% by weight of the composition. Preferably the nonionic surfactant, and the amphoteric surfactant, when present in the composition, are each individually present in an effective amount, more preferably from about 0.1% to about 20%, even more preferably about 0.1% to about 15%, even more preferably still from about 0.5% to about 10%, by weight.

### Suds Suppresser

The suds suppresser useful herein is well known to those skilled in the art of automatic laundry washing, but has not been previously used in the field of hand dishwashing, as research in the field of hand dishwashing has generally focused on increasing the sudsing profile of a hand dishwashing composition. Suds suppressers useful herein are generally described in, for example, Kirk Othmer Encyclopedia of Chemical Technology, Third Edition, Volume 7, pages 430-447 (John Wiley & Sons, Inc., 1979). However, from a cost, solubility, and consumer benefit standpoint, a preferred suds suppresser useful herein is selected from the group consisting of monocarboxylic fatty acid suds suppresser, a monocarboxylic fatty acid salt suds suppresser, a silicone suds suppresser, and a mixture thereof, and is more preferably selected from the group consisting of a silicone suds suppresser and a mixture thereof. Without intending to be limited by theory, it is believed that a silicone suds suppresser is especially preferred, as they are generally more effective at reducing the surface tension at the air-water interface, and yet do not significantly affect the detergency at the water-oil interface.

One category of suds suppresser useful herein encompasses monocarboxylic fatty acids and soluble salts thereof. See U.S. Pat. No. 2,954,347 to Wayne, issued Sep. 27, 1960. The monocarboxylic fatty acids and salts thereof useful herein typically have hydrocarbyl chains of 10 to about 24 carbon atoms, preferably 12 to 18 carbon atoms. Suitable salts include the alkali metal salts such as sodium, potassium, and lithium salts, and ammonium and/or alkanolammonium salts thereof, preferably the sodium, potassium, ammonium salts and/or alkanolammonium salts thereof.

Another preferred category of suds suppresser includes silicone suds suppressers. This category includes the use of polyorganosiloxane oils, such as polydimethylsiloxane, dispersions or emulsions of polyorganosiloxane oils or resins, and combinations of polyorganosiloxane with silica particles wherein the polyorganosiloxane is chemisorbed or fused onto the silica. Silicone suds suppressers are, for example, disclosed in U.S. Pat. No. 4,265,779 to Gandolfo, et al., issued May 5, 1981 and European Patent Application No. 89307851.9 to Starch, published Feb. 7, 1990. Other silicone suds suppressers are disclosed in U.S. Pat. No. 3,455,839 to Rauner, issued Jul. 15, 1969 which relates to compositions and processes for defoaming aqueous solutions by incorporating therein small amounts of polydimethylsiloxane fluids.

Mixtures of silicone and silanated silica suds suppressers are described, for instance, in German Patent Application DOS 2,124,526 to Bartolotta and Eymery, issued Jun. 28, 1979. Silicone defoamers and suds controlling agents in granular detergent compositions are disclosed in U.S. Pat. No. 3,933,672 to Bartolotta, et al., issued Jan. 20, 1976 and in U.S. Pat. No. 4,652,392 to Baginski, et al., issued Mar. 24, 1987.

An exemplary silicone based suds suppresser for use herein is a suds suppressing amount of a suds controlling agent consisting essentially of:

(i) polydimethylsiloxane fluid having a viscosity of from about 20 cps. to about 1,500 cps. at 25° C.;

(ii) from about 5 to about 50 parts per 100 parts by weight of (i) of siloxane resin composed of (CH₃)₃SiO_{1/2} units of SiO₂ units in a ratio of from (CH₃)₃ SiO_{1/2} units and to SiO₂ units of from about 0.6:1 to about 1.2:1; and

(iii) from about 1 to about 20 parts per 100 parts by weight of (i) of a solid silica gel.

In a preferred silicone suds suppresser used herein, the solvent for a continuous phase is made up of certain polyethylene glycols or polyethylene-polypropylene glycol copolymers or mixtures thereof (preferred), or polypropylene glycol. The primary silicone suds suppresser is branched/crosslinked and preferably not linear.

The silicone suds suppresser preferably includes (1) a nonaqueous emulsion of a primary antifoam agent which is a mixture of (a) a polyorganosiloxane, (b) a resinous siloxane or a silicone resin-producing silicone compound, (c) a finely divided filler material, and (d) a catalyst to promote the reaction of mixture components (a), (b) and (c), to form silanolates; (2) at least one nonionic silicone surfactant; and (3) polyethylene glycol or a copolymer of polyethylene-polypropylene glycol having a solubility in water at room temperature of more than about 2 weight %; and without polypropylene glycol. See also U.S. Pat. No. 4,978,471 to Starch, issued Dec. 18, 1990, and U.S. Pat. No. 4,983,316 to Starch, issued Jan. 8, 1991, and U.S. Pat. No. 5,288,431 to Huber, et al., issued Feb. 22, 1994.

The silicone suds suppresser herein preferably includes polyethylene glycol and a copolymer of polyethylene glycol/polypropylene glycol, all having an average molecular weight of less than about 1,000, and preferably of from about 100 to about 800. The polyethylene glycol and polyethylene/polypropylene copolymers herein have a solubility in water at room temperature of more than about 2 weight %, and preferably more than about 5 weight %. The preferred solvent herein is polyethylene glycol having an average molecular weight of less than about 1,000, more preferably of from about 100 to about 800, and more preferably of from about 200 to about 400, and a copolymer of polyethylene glycol/polypropylene glycol, preferably PPG 200/PEG 300. Preferably, the suds suppresser has a weight ratio of polyethylene glycol:copolymer of polyethylene-polypropylene glycol of from about 1:1 to about 1:10, and more preferably of from about 1:3 to about 1:6. Alternatively, these polymeric suds suppressers may be present in place of a silicone suds suppresser.

A highly preferred silicone suds suppresser mixture is DOW CORNING® 2-3000 ANTIFOAM, available from Dow Corning (Midland, Mich., USA), having a viscosity of about 3500 cps, and DOW CORNING® 544 ANTIFOAM, DOW CORNING® 1400 ANTIFOAM, DOW CORNING® 1410 ANTIFOAM, and other similar products available from Dow Corning. Such silicone suds suppressers are especially preferred, as it has now been found that they may provide an improved solution feel during washing, and can enhance the “squeaky-clean” feel and sound desired by many consumers when washing ceramics, plastics, etc. Furthermore, it has now been found that a silicone suds suppresser may also provide a sheeting benefit on a dish which in turn repels water and thus decreases both rinsing time and drying time. This further minimizes the amount of water necessary for rinsing. In addition, a silicone suds suppresser may provide a thickening benefit without adversely affecting the dissolution profile of the hand dishwashing composition. This is especially useful where a high viscosity hand dishwashing composition is desired.

The hand dishwashing composition herein may also contain a non-surfactant suds suppresser such as, for example: a high molecular weight hydrocarbon such as paraffin, a fatty acid ester (e.g., fatty acid triglycerides), a fatty acid ester of a monovalent alcohol, an aliphatic C₁₈-C₄₀ ketone (e.g., stearone), etc. Also useful herein is an N-alkylated amino triazine such as tri- to hexa-alkylmelamines or di- to tetra-alkyldiamine chlortriazines formed as products of cyanuric chloride with two or three moles of a primary or secondary amine containing from about 1 to about 24 carbon atoms, propylene oxide, and monostearyl phosphates, such as monostearyl alcohol phosphate ester and monostearyl di-alkali metal (e.g., K, Na, and Li) phosphates and phosphate esters. The hydrocarbons such as paraffin and haloparaffin can be utilized in liquid form. The liquid hydrocarbons will be liquid at room temperature and atmospheric pressure, and will have a pour point in the range of about −40° C. and about 50° C., and a minimum boiling point not less than about 110° C. (at atmospheric pressure). It is also known to utilize waxy hydrocarbons, preferably having a melting point below about 100° C. Hydrocarbon suds suppressers are described, for example, in U.S. Pat. No. 4,265,779 to Gandolfo, et al., issued May 5, 1981. The hydrocarbons, thus, include aliphatic, alicyclic, aromatic, and heterocyclic saturated or unsaturated hydrocarbons having from about 12 to about 70 carbon atoms. The term “paraffin,” as used in this suds suppresser discussion, is intended to include mixtures of true paraffins and cyclic hydrocarbons. Such suds suppressers are available from a variety of commercial sources. Other suds suppressers useful herein comprise the secondary alcohols (e.g., 2-alkyl alkanols) and mixtures of such alcohols with silicone oils. The secondary alcohols include the C₆-C₁₆ alkyl alcohols having a C₁-C₁₆ chain. A preferred alcohol is 2-butyl octanol, which is available from Condea under the trademark ISOFOL™ 12. Mixtures of secondary alcohols are available under the trademark ISALCHEM™ 123 from Enichem. Mixed suds suppressers typically comprise mixtures of alcohol+silicone at a weight ratio of 1:5to 5:1.

Suds suppressers are present in a “suds suppressing amount”. The term “suds suppressing amount” means that the formulator can select an amount of this suds controlling agent that will sufficiently control the suds to result in a reduced sudsing profile. When utilized as suds suppressers, the monocarboxylic fatty acids and salts thereof, will typically be present up to about 10%, and preferably from about 3% to about 7%, by weight. Silicone suds suppressers are typically utilized in amounts up to about 10%, preferably from about 0.05% to about 6%, and more preferably from about 0.1% to about 5%, by weight, although higher amounts may be used. This upper limit is practical in nature, due primarily to concern with minimizing costs and due to the surprising effectiveness of lower levels of silicone suds suppresser to control the sudsing profile. As used herein, these weight percentage values include any silica that may be utilized in combination with polyorganosiloxane, as well as any adjunct materials that may be utilized. Other suds suppressers useful herein may be employed in an effective amount which may be determined by one skilled in the art.

The hand dishwashing composition may be in any suitable form, but is preferably in a gel form, a paste form, a liquid form, and preferably a liquid form. If in a liquid form, the composition herein typically has a pH, as measured as a 10% solution thereof, of greater than about 6; preferably the pH is greater than about 6; more preferably the pH is from about 7 to about 10; and even more preferably the pH is from about 8 to about 10.

### Adjunct Ingredients

In order to maintain the pH at the optimum level it may be preferably to include a buffering agent capable of providing a generally more alkaline pH in the composition and in dilute solutions. Dishwashing compositions of the present invention may therefore contain from 0.1% to 15%, preferably from 1% to 10%, most preferably from 2% to 8%, by weight, of a buffering agent. The pKₐ value of this buffering agent should be about 0.5 to 1.0 pH units below the desired pH value of the composition. Preferably, the pKₐ of the buffering agent should be greater than 5.

Preferred inorganic buffers/alkalinity sources include the alkali metal carbonates, alkali metal hydroxides and alkali metal phosphates, e.g., sodium carbonate, sodium hydroxide, sodium polyphosphate. The buffering agent may be an active detergent in its own right, or it may be a low molecular weight, organic or inorganic material that is used in this composition solely for maintaining an alkaline pH. Preferred buffering agents for compositions of this invention are nitrogen-containing materials. Some examples are amino acids such as lysine or lower alcohol amines like mono-, di-, and tri-ethanolamine. Diamines, described in detail below, also act as buffering agents and are preferred herein. A preferred buffering system for use herein includes a combination of 0.5% diamine and 2.5% citrate and a combination of 0.5% diamine, 0.75% potassium carbonate and 1.75% sodium carbonate. Other preferred nitrogen-containing buffering agents are Tri(hydroxymethyl)amino methane (HOCH2)3CNH3 (TRIS), 2-amino-2-ethyl-1,3-propanediol, 2-amino-2-methyl-propanol, 2-amino-2-methyl-1,3-propanol, disodium glutamate, N-methyl diethanolamide, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Mixtures of any of the above are also acceptable. For additional buffers see McCutcheon's EMULSIFIERS AND DETERGENTS, North American Edition, 1997, McCutcheon Division, MC Publishing Company Kirk and WO 95/07971 to Mao, et al., published on Mar. 23, 1995.

The present invention may also comprise a linear or cyclic carboxylic acid or salt thereof. Where the acid or salt thereof is linear, it typically comprises from 1 to 6 carbon atoms whereas where the acid is cyclic, it typically comprises greater than 3 carbon atoms. The linear or cyclic carbon-containing chain of the carboxylic acid or salt thereof may be substituted with a substituent group selected from the group consisting of hydroxyl, ester, ether, aliphatic groups having from about 1 to about 6, and more preferably about 1 to about 4 carbon atoms and mixtures thereof.

The carboxylic acids or salts thereof preferably have a pKₐ₁ of less than about 7, and more preferably from about 1 to about 3. The carboxylic acid and salts thereof may comprise one or two or more carboxylic groups.

Suitable carboxylic acids or salts thereof are those having the general formula:

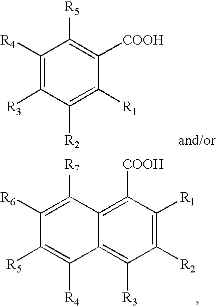

where R₁, R₂, R₃, R₄, R₅, R₆, and R₇ are selected from the group consisting of an alkyl chain having from about 1 to about 3 carbon atoms, a hydroxy group, hydrogen, an ester group, and a carboxylic acid group with the proviso that no more than 3 carboxylic acid groups are present.

A preferred carboxylic acid is selected from the group consisting of salicylic acid, maleic acid, acetyl salicylic acid, 3-methyl salicylic acid, 4-hydroxy isophthalic acid, dihydroxyfumaric acid, 1,2,4-benzene tricarboxylic acid, pentanoic acid and salts thereof and a mixture thereof. Where the carboxylic acid exists in the salt form, the cation of the salt is preferably selected from an alkali metal, an alkaline earth metal, monoethanolamine, diethanolamine, triethanolamine and a mixture thereof.

If present, the carboxylic acid or salt thereof is present at the level of from about 0.1% to about 5%, more preferably from about 0.2% to about 1% and even more preferably from about 0.25% to about 0.5%, by weight of the hand dishwashing composition.

The hand dishwashing composition herein may also include optional ingredients for example a diamine, an additional surfactant, an organic solvent, an aqueous liquid carrier, an enzyme, a builder, a perfume, a chelating agent and a mixture thereof. However, it is highly preferred that the present invention be substantially free of a suds stabilizing agent, such as a polymeric suds stabilizing agent, which would increase the sudsing profile.

In the context of a hand dishwashing composition, the “usage levels” of a diamine in the compositions herein can vary depending not only on the type and severity of the soils and stains, but also on the wash water temperature, the volume of wash water and the length of time the dishware is contacted with the wash water. The hand dishwashing composition will preferably contain from about 0.1% to about 15%, more preferably from about 0.2% to about 10%, even more preferably from about 0.25% to about 6%, and even more preferably still from about 0.5% to about 5%, by weight of a diamine.

The diamine herein is preferably substantially free from impurities. By “substantially free” it is meant that the diamines are over 95% pure, i.e., preferably 97%, more preferably 99%, still more preferably 99.5%, free of impurities. Examples of possible diamine impurities include 2-Methyl-1,3-diaminobutane and alkylhydropyrimidine. Further, the diamines should be free of oxidation reactants to avoid diamine degradation and ammonia formation.

Preferred organic diamines have a pKₐ₁ and pKₐ₂ in the range of from about 8.0 to about 11.5, preferably from about 8.4 to about 11, even more preferably from about 8.6 to about 10.75. Preferred diamines are 1,3-bis(methylamine)-cyclohexane (pKa=10 to 10.5), 1,3 propane diamine (pKₐ₁=10.5; pKₐ₂=8.8), 1,6 hexane diamine (pKₐ₁=11; pKₐ₂=10), 1,3 pentane diamine (Dytek EP) (pKₐ₁=10.5; pKₐ₂=8.9), 2-methyl 1,5 pentane diamine (Dytek A) (pKₐ₁=11.2; pKₐ₂=10.0). Other preferred diamines are the primary/primary diamines with C4 to C8 alkylene spacers. In general, primary diamines are preferred over secondary and tertiary diamines.

As used herein, “pKₐ₁” and “pKₐ₂” are quantities of a type collectively known to those skilled in the art as “pKₐ”, which is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKₐs can be obtained from relevant company literature, such as information supplied by Dupont, a supplier of diamines.

As a working definition herein, the pKₐ of the diamine is specified in an all-aqueous solution at 25° C. and for an ionic strength between 0.1 to 0.5 M. The pKₐ is an equilibrium constant which can change with temperature and ionic strength; thus, values reported in the literature are sometimes not in agreement depending on the measurement method and conditions. To eliminate ambiguity, the relevant conditions and/or references used for pKₐs of this invention are as defined herein or in “Critical Stability Constants: Volume 2, Amines”. One typical method of measurement is the potentiometric titration of the acid with sodium hydroxide and determination of the pKₐ by suitable methods as described and referenced in “The Chemist's Ready Reference Handbook” by Shugar and Dean, McGraw Hill, NY, 1990.

It has been determined that substituents and structural modifications that lower pKₐ₁ and pKₐ₂ below about 8.0 are undesirable and cause losses in performance. This can include substitutions that lead to ethoxylated diamines, hydroxy ethyl substituted diamines, diamines with oxygen in the beta (and less so gamma) position to the nitrogen in the spacer group (e.g., Jeffamine EDR 148). In addition, materials based on ethylene diamine are typically unsuitable.

The diamines useful herein can be defined by the following structure:

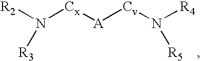

where R₂₋₅ are independently selected from H, methyl, —CH₃CH₂, and ethylene oxides; Cₓ and Cᵥ are independently selected from methylene groups or branched alkyl groups where x+y is from about 3 to about 6; and where A is optionally present and is selected from electron donating or withdrawing moieties chosen to adjust the diamine pKₐs to the desired range. If A is present, then x and y must both be 1 or greater.

Examples of preferred diamines can be found in WO 99/63034 to Vinson, et al., published on Dec. 9, 1999.

### Additional Surfactants

The present invention preferably includes an additional surfactant, especially polyhydroxy fatty acid amide surfactant. The compositions herein may also contain an effective amount of polyhydroxy fatty acid amide surfactant. In general, the incorporation of about 1%, by weight, polyhydroxy fatty acid amide will enhance cleaning performance.

The composition may include about 1% by weight polyhydroxy fatty acid amide surfactant, preferably from about 3% to about 30% by weight, of a polyhydroxy fatty acid amide. The polyhydroxy fatty acid amide surfactant component has the formula:

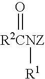

where R¹ is H, C₁-C₄ hydrocarbyl, 2-hydroxy ethyl, 2-hydroxy propyl, or a mixture thereof, preferably C₁-C₄ alkyl, more preferably C₁ or C₂ alkyl, and even more preferably methyl; and R² is a C₅-C₃₁ hydrocarbyl, preferably straight chain C₇-C₁₉ alkyl or alkenyl, more preferably straight chain C₉-C₁₇ alkyl or alkenyl, and even more preferably straight chain C₁₁-C₁₅ alkyl or alkenyl, or mixtures thereof; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z preferably will be derived from a reducing sugar in a reductive amination reaction; more preferably Z will be a glycityl moiety. Suitable reducing sugars include glucose, fructose, maltose, lactose, galactose, mannose, and xylose. As raw materials, high dextrose corn syrup, high fructose corn syrup, and high maltose corn syrup can be utilized as well as the individual sugars listed above. These corn syrups may yield a mix of sugar components for Z. It should be understood that it is by no means intended to exclude other suitable raw materials. Z preferably will be selected from the group consisting of —CH₂—(CHOH)ₙ—CH₂OH, —CH(CH₂OH)—(CHOH)ₙ₋₁—CH₂OH, —CH₂—(CHOH)₂(CHOR′)(CHOH)—CH₂OH, and alkoxylated derivatives thereof, where n is an integer from 3 to 5, inclusive, and R′ is H or a cyclic or aliphatic monosaccharide. Most preferred are glycityls wherein n is 4, particularly —CH₂—(CHOH)₄—CH₂OH.

R′ can be, for example, N-methyl, N-ethyl, N-propyl, N-isopropyl, N-butyl, N-2-hydroxy ethyl, or N-2-hydroxy propyl. In the above formula, R²—C(O)—N< may be, for example, cocamide, stearamide, oleamide, lauramide, myristamide, capricamide, palmitamide, tallowamide, etc. Z can be 1-deoxyglucityl, 2-deoxyfructityl, 1-deoxymaltityl, 1-deoxylactityl, 1-deoxygalactityl, 1-deoxymannityl, 1-deoxymaltotriotityl, etc.

### Organic Solvent

The present invention preferably includes an organic solvent. Organic solvents are broadly defined as organic compounds that are liquid at temperatures of 20-25° C. and which are not considered to be surfactants. One of the distinguishing features is that organic solvents tend to exist as discrete entities rather than as broad mixtures of compounds.

Suitable organic solvents include diols polymeric glycols and mixtures thereof. Diols suitable herein have the following formula:

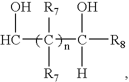

where n=0-3, R₇=H, methyl or ethyl; and R₈=H, methyl, ethyl, propyl, isopropyl, butyl or isobutyl. Preferred diols include propylene glycol, 1,2-hexanediol, 2-ethyl-1,3-hexanediol and 2,2,4-trimethyl-1,3-pentanediol. When present, the composition will include from about 0.5% to about 20%, more preferably from about 1% to about 10%, even more preferably from about 3% to about 6% by weight of a diol.

Polymeric glycols, which comprise ethylene oxide (EO) and propylene oxide (PO) groups may also be included herein. These materials are formed by adding blocks of ethylene oxide moieties to the ends of polypropylene glycol chains. Polymeric glycols suitable for use in the present invention are of the following formula:

(PO)ₓ(EO)_{y}H,

where x+y is from about 17 to 68, and x/(x+y) is from about 0.25 to 1.0. A preferred polymeric glycol is a polypropylene glycol (corresponding to when y≈0) having an average molecular weight of between about 1,000 to about 5,000, more preferably between about 2,000 to about 4,000, most preferably about 2,000 to about 3,000.

The polymeric glycol useful herein is present at from about 0.25% to about 5%, more preferably from about 0.5% to about 3%, even more preferably from about 0.75% to about 2% by weight of the composition.

To insure satisfactory physical stability, if polymeric glycols are added, it may be necessary to also include either a diol and/or an alkali metal inorganic salt, such as sodium chloride. Furthermore, the addition of a diol can improve the physical and enzymatic stability of a liquid dishwashing composition. Suitable amounts of diols to provide physical stability are in the amounts in the ranges found above, while a suitable amount of an alkali metal inorganic salt is from about 0.1% to about 1.5%, preferably from about 0.1% to about 0.8% by weight of the composition.

Other suitable organic solvents, including lower alkanols, diols, other polyols, ethers, amines, and the like, may be used herein. Particularly preferred are the C1-C4 alkanols. Particularly useful organic solvents include, but are not limited to, butyl diglycol ether (BDGE), butyltriglycol ether, ter amilic alcohol, butoxy propoxy propanol, butyl diglycol ether, benzyl alcohol, butoxypropanol, ethanol, methanol, isopropanol and mixtures thereof.

Other suitable organic solvents for use herein include propylene glycol derivatives such as n-butoxypropanol or n-butoxypropoxypropanol, water-soluble CARBITOL R organic solvents or water-soluble CELLOSOLVE R organic solvents; water-soluble CARBITOL R organic solvents are compounds of the 2-(2-alkoxyethoxy)ethanol class wherein the alkoxy group is derived from ethyl, propyl or butyl; a preferred water-soluble carbitol is 2-(2-butoxyethoxy)ethanol also known as butyl carbitol. Water-soluble CELLOSOLVE R organic solvents are compounds of the 2-alkoxyethoxy ethanol class, with 2-butoxyethoxyethanol being preferred. Other suitable organic solvents include benzyl alcohol, and diols such as 2-ethyl-1,3-hexanediol and 2,2,4-trimethyl-1,3-pentanediol and mixtures thereof. Some preferred organic solvents for use herein are n-butoxypropoxypropanol, BUTYL CARBITOL O and a mixture thereof.

The organic solvents can be selected from ether derivatives of mono-, di- and tri-ethylene glycol, butylene glycol ethers, and mixtures thereof. The molecular weights of these organic solvents are preferably less than 350, more preferably between 100 and 300, and even more preferably between 115 and 250. Examples of preferred organic solvents include, mono-ethylene glycol n-hexyl ether, mono-propylene glycol n-butyl ether, and tri-propylene glycol methyl ether. Ethylene glycol and propylene glycol ethers are commercially available from the Dow Chemical Company under the tradename DOWANOL™ and from the Arco Chemical Company under the tradename ARCOSOLV™. Other preferred organic solvents include mono- and di-ethylene glycol n-hexyl ether, and are available from the Union Carbide Company.

When present, the composition will preferably contain from about 0.01% to about 20%, more preferably at least about 0.5% to about 10%, even more preferably from about 1 % to about 8% by weight of organic solvent.

### Aqueous Liquid Carrier

The organic solvent, if present, may be used in conjunction with an aqueous liquid carrier, preferably water, or may be used without any aqueous liquid carrier being present. If present, the aqueous carrier is typically present at a level of from about 1% to about 90%, preferably from about 25% to about 80%, and more preferably from about 50% to about 70%, by weight.

### Enzymes

The present invention may include one or more enzymes which provide cleaning performance benefits. Enzymes useful herein include a cellulase, a hemicellulase, a peroxidase, a protease, a gluco-amylase, an amylase, a lipase, a cutinase, a pectinase, a xylanase, a reductase, an oxidase, a phenoloxidase, a lipoxygenase, a ligninase, a pullulanase, a tannase, a pentosanase, a malanase, a β-glucanase, an arabinosidase and a mixture thereof. A preferred combination is a detergent composition having a cocktail of conventional applicable enzymes such as protease, amylase, lipase, cutinase and/or cellulase. An enzyme is typically present at from about 0.0001% to about 5% of active enzyme, by weight. Preferred proteolytic enzymes are selected from the group consisting of ALCALASE® (Novo Industri A/S), BPN′, Protease A and Protease B (Genencor), and mixtures thereof. Protease B is more preferred. Preferred amylase enzymes include TERMAMYL®, DURAMYL® and the amylase enzymes described in WO 9418314 to Genencor International and WO 9402597 to Novo. Further non-limiting examples of suitable and preferred enzymes are disclosed in WO 99/63034 to Vinson, et al., published on Dec. 9, 1999.

Because hydrogen peroxide and builders such as citric acid and citrates impair the stability of enzymes, it is desirable to reduce or eliminate the levels of these compounds in compositions which contain enzymes, or otherwise protect the enzymes from these compounds. Hydrogen peroxide and/or amines are often found as an impurity in surfactants and surfactant pastes. As such, the preferred level of hydrogen peroxide and/or amine in the amine oxide or surfactant paste, betaine, etc. is from 0-40 ppm, more preferably from 0-15 ppm.

### Builder

The present invention may further include a builder system. Because builders such as citric acid and citrates may impair the stability of enzymes, it is desirable to reduce the amounts or completely remove the builder salts normally utilized by incorporating propylene glycol as an organic solvent and builder. Without intending to be limited by theory, it is believe that when a detergent composition includes propylene glycol solvent as a part or a whole of the detergent's carrier, enzymes are more stable and smaller amounts or no builder salts are needed.

If desired, then any conventional builder system may be used herein, including an aluminosilicate material, a silicate, a polycarboxylate, a fatty acid, materials such as ethylene-diamine tetraacetate, metal ion sequestrants such as an amino polyphosphonate, particularly ethylenediamine tetramethylene phosphonic acid and diethylene triamine pentamethylene-phosphonic acid, and a mixture thereof. Although less preferred for environmental reasons, phosphate builders can also be used herein. If builders are included, they are typically present at from about 0.5% to about 50%, preferably from about 5% to about 30%, and more preferably from about 5% to about 25% by weight.

### Perfumes

The perfume useful herein includes a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can include extremely complex mixtures of such ingredients. Finished perfumes typically comprise from about 0.01% to about 2%, by weight, and individual ingredients can comprise from about 0.0001% to about 90% of a finished perfume composition. Non-limiting examples of perfume ingredients useful herein can be found in WO 99/63034 to Vinson, et al., published on December 9, 1999.

### Chelating Agent

The present invention may also optionally contain one or more chelating agents, especially an iron and/or manganese chelating agent. Such a chelating agent may be selected from an amino carboxylate, an amino phosphonate, a polyfunctionally-substituted aromatic chelating agent and a mixture thereof. Without intending to be bound by theory, it is believed that the benefit of these materials is due in part to their exceptional ability to remove iron and manganese ions from washing solutions by formation of soluble chelates. Preferred chelating agents useful herein are described in U.S. Pat. No. 3,812,044, issued May 21, 1974, to Connor, et al.; and U.S. Pat. No. 4,704,233 to Hartman and Perkins, granted on Nov. 3, 1987.

If utilized, these chelating agents will generally comprise from about 0.00015% to about 15% by weight. More preferably, if utilized, the chelating agents will comprise from about 0.0003% to about 3.0% by weight.

### Other Adjunct Ingredients

The present invention may further include one or more detersive adjuncts selected from: soil release polymers, polymeric dispersants, polysaccharides, magnesium ions, abrasives, bactericides and other antimicrobials, tarnish inhibitors, dyes, antifungal or mildew control agents, insect repellents, hydrotropes, thickeners, processing aids, brighteners, anti-corrosive aids, stabilizers, antioxidants and a mixture thereof.

### Non-Aqueous Liquid Detergents

The manufacture of liquid detergent compositions which comprise a non-aqueous carrier medium can be prepared according to the disclosures of U.S. Pat. Nos. 4,753,570; 4,767,558; 4,772,413; 4,889,652; 4,892,673; GB-A-2,158,838; GB-A-2,195,125; GB-A-2,195,649; U.S. Pat. No. 4,988,462; U.S. 5,266,233; EP-A-225,654 (Jun. 16, 1987); EP-A-510,762 (Oct. 28, 1992); EP-A-540,089 (May 5, 1993); EP-A-540,090 (May 5, 1993); U.S. Pat. No. 4,615,820; EP-A-565,017 (Oct. 13, 1993); EP-A-030,096 (Jun. 10, 1981). Such compositions can contain various particulate detersive ingredients stably suspended therein. Such non-aqueous compositions thus comprise a liquid phase and, optionally but preferably, a solid phase, all as described in the cited references. Other methods for forming the hand dishwashing composition of the present invention are known in the art, and may be used to form the present invention.

### Method For Reducing The Amount Of Water Used In The Rising Step

The present invention also relates to a process for cleaning a dish and/or washware which results in a reduction of the amount of water used in the rinsing step. The dish and/or washware is contacted, either directly or indirectly, with the hand dishwashing composition herein. The composition may be applied to the dish and/or washware in neat and/or in dilute form. Thus, the dish may be cleaned singly by applying the composition directly to the dish and/or may be cleaned by dispersing the composition with water in a suitable vessel, for example a dishwashing basin, a sink or bowl or other appropriate washware, and then applying this dispersed composition to a number of dishes with a washing implement such as a sponge, brush, scrub pad, etc. In a further alternative process the composition can be used in dilute form in a suitable vessel as a soaking medium for hard-to-clean dishes. Furthermore, in a preferred process, the composition is applied to a washing implement, such as a sponge, a steel wool pad, etc., and then applied to a dish.

When applied either directly or indirectly to the dish, the composition will typically cause suds to be left on the dish. Thus, the dish will usually be rinsed with water to remove the suds, oils, food materials, etc., before allowing it to dry. It has now been found that significant amounts of water are also used to rinse suds from the washware, especially from the dishwashing basin and/or the sink. Once the suds are removed, drying of the dish and/or washware may take place passively by allowing for the natural evaporation of water or actively using any suitable drying equipment, for example a cloth or towel.

Without being limited by theory, it is believed that use of the hand dishwashing composition described herein may significantly reduce the amount of water required to remove the suds from the dish and washware, as compared to the amount of water required to similarly remove suds from the dish and washware, when a comparable hand dishwashing composition, lacking the suds suppresser is similarly employed. Preferably, the rinse water reduction according to the method of the present invention is least about 10%, more preferably at least about 25%, even more preferably at least 35%, and still more preferably at least about 50%, as compared to the amount of water used in the rinsing step for a comparable hand dishwashing composition lacking the suds suppresser. Such a water reduction is measured by the testing method described herein.

### Rinse Water Reduction Test

The amount of water used in the rinsing step can be quantified by the following test method:

1. Measure the running water rate in mL/second for room temperature water.

2. Prepare 2 sets of 5 similarly-soiled plates. Prepare a “test” dishwashing composition with the suds suppresser, and a “control” dishwashing composition which lacks the suds suppresser.

3. Add sufficient dishwashing composition to 2 liters of water in a 4 liter plastic wash basin, so as to make a washing bath having a total sudsing surfactant concentration of 0.1%, by weight.

4. Vigorously agitate the washing bath for 30 seconds to generate suds, and then wash all 5 plates of the 1^{st} set of soiled plates in the washing bath with a sponge, until soil is removed from all of the plates. Once washed, the plates are set aside, outside of the wash basin.

5. Empty the wash basin into sink. Rinse the plates, wash basin, sponge, and sink with running water, while recording the amount of time it takes to completely remove the suds from the plates, wash basin, sponge, and sink.

6. Multiply the running water rate by the rinsing time to find the total amount of water used for the composition (i.e., the “total water of test/control composition”, in the formula, below).

7. Repeat steps 3-6 with the “control” dishwashing solution to make a “control” washing bath and use it to wash the 2^{nd} set of soiled plates.

8. Compare the total amount of water used by the test dishwashing composition and the control dishwashing composition. The amount of reduction of water used in the rinsing step when employing a composition according to the present invention, as compared to the control dishwashing composition lacking the suds suppresser, can thus be calculated as:

$$\begin{matrix}Rinse Water \\ Reduction\end{matrix} = [ 1 - \frac{( Total water of test composition )}{( Total water of control composition )} ] * 100$$

As noted above, the rinse water reduction according to the method of the present invention is least about 10%, more preferably at least about 25%, even more preferably at least 35%, and still more preferably at least about 50%, as compared to the amount of water used in the rinsing step for a comparable hand dishwashing composition lacking the suds suppresser.

### Sudsing Profile Reduction Test

The sudsing profile can be measured by employing a suds cylinder tester (SCT), having a set of 4 cylinders. Each cylinder is typically 30 cm long, and 10 cm in diameter. The cylinder walls are 0.5 cm thick, and the cylinder bottom is 1 cm thick. The SCT rotates a test solution in a closed cylinder, typically a plurality of clear plastic cylinders, at a rate of about 21 revolutions per minute, for a standard period of time, after which the suds height is measured. Soil may then be added to the test solution, agitated again, and the resulting suds height measured, again. Such a test may be used to simulate the initial sudsing profile of a hand dishwashing composition, as well as its sudsing profile during use, as more soils are introduced to the hand dishwashing solution from the dishes being washed.

The test method for the sudsing profile reduction test herein is as follows:

1. Prepare a “test” dishwashing composition with the suds suppresser, and a “control” dishwashing composition which lacks the suds suppresser.

2. Prepare a set of clean, dry, calibrated cylinders, and water having a water hardness of 136.8 parts per million (2.1 grains per liter), and having a temperature of 25° C.

3. Add sufficient test dishwashing composition to each cylinder so as to provide a total sudsing surfactant concentration of 0.1%, when 500 mL of water is added to each cylinder.

4. Add 500 mL water to each cylinder, and make sure the dishwashing composition is completely dissolved. Seal the cylinders and place them in the SCT.

5. Turn on the SCT and rotate the cylinders for 2 minutes.

6. Within 1 minute, measure the height of the suds in centimeters.

7. Repeat steps 2-6 with the control solution.

8. The sudsing profile is the average level of suds, in cm, generated by the dishwashing composition. The sudsing profile reduction, at any given time point, when employing a composition according to the present invention, as compared to the control dishwashing composition lacking the suds suppresser, can thus be calculated as:

$$\begin{matrix}Sudsing Profile \\ Reduction\end{matrix} = [ 1 - \frac{( Suds height of test composition )}{( Suds height of control composition )} ] * 100.$$

The initial sudsing profile reduction (i.e., before any soils are added to the cylinders) according to the present invention is least about 10%, more preferably at least about 13%, and even more preferably at least 15%, as compared to the sudsing profile for a comparable hand dishwashing composition lacking the suds suppresser. Furthermore, it has been found that the sudsing profile reduction during use may significantly increase. However, the magnitude of the actual reduction during use depends significantly on factors such as water hardness, soil type, suds suppresser, and the actual sudsing surfactant(s) employed. To simulate such in-use suds profiles, a standardized amount of a prepared soil may be added to each cylinder in between Steps 6 and 7, above. The SCT then rotates the cylinders for 1 minute, to simulate washing, and the suds levels are re-measured. This addition step may be repeated until the suds level falls below a pre-determined level, for example, 1 cm.

Examples of the invention are set forth hereinafter by way of illustration and are not intended to be in any way limiting of the invention.

### EXAMPLE 1

The following liquid hand dishwashing compositions according to the present invention are prepared.

| | I | II | III | IV | V | VI |
|---|---|---|---|---|---|---|
| Na C₁₂₋₁₄E_{0.6}S avg. degree of | 27 | — | — | — | 27 | — |
| branching 15-20% | | | | | | |
| Na C₁₂₋₁₄E_{0.6}S avg. degree of | — | 27 | 20 | — | — | — |
| branching 40-50% | | | | | | |
| Na C₁₂₋₁₄E_{1.4}S avg. degree of | — | — | — | — | — | 24 |
| branching 40-50% | | | | | | |
| Na C₁₂₋₁₄E₃S | — | — | — | 27 | — | — |
| Amine oxide C₁₂₋₁₄ | 6.5 | 6.5 | 4 | 6.5 | 6.5 | 2 |
| C₁₂₋₁₄ glucose amide | — | — | — | — | — | 3 |
| Alkyl dimethyl betaine | — | — | — | — | — | 2 |
| C₁₀E₈ nonionic surfactant | 3 | 3 | 5 | 3 | 3 | 4 |
| 1,3 cyclohexane bis | 0.5 | 0.5 | — | 0.5 | 0.5 | — |
| (methylamine) | | | | | | |
| Homopolymer of dimethyl | 0.2 | 0.2 | — | 0.2 | 0.2 | — |
| aminoethyl methacrylate | | | | | | |
| Silicone suds suppresser | 4 | 2 | — | 2 | 4 | — |
| (DOW CORNING ® 2-3000 | | | | | | |
| ANTIFOAM) | | | | | | |
| C₁₂₋₁₄ fatty acid suds | — | — | 3 | — | — | 4 |
| suppresser | | | | | | |
| Ethanol | 6 | 7 | 5 | 6 | 6 | 7 |
| Sodium cumene sulfonate | 2 | 4 | 3 | 4 | 6 | 4.5 |
| Perfume | 0.35 | 0.35 | 0.2 | 0.35 | 0.35 | 0.2 |
| NaOH | to pH | to pH | to pH | to pH | to pH | to pH |
| | 8.4 | 8.4 | 7 | 8.4 | 8.4 | 7.8 |
| Water, adjunct ingredients | bal. | bal. | bal. | bal. | bal. | bal. |

All amounts are in weight percent, unless specifically noted otherwise.

These compositions have a viscosity of about 330 cps, and provide acceptable cleaning, especially of grease and oils. Furthermore, these compositions also have a reduced sudsing profile as compared to comparable compositions lacking the suds suppresser. During use, these compositions provide a rinse water reduction of over 10%.

### EXAMPLE 2

A control hand dishwashing composition (Comparative Composition 1) according to Composition II in Example 1 is provided, except that the pH is adjusted to 9, and it lacks a silicone suds suppresser. Two test hand dishwashing compositions according to the present invention are provided. Composition A is formed by adding 2% silicone suds suppresser (DOW CORNING® 2-3000 ANTIFOAM) to the Comparative Composition 1, and Composition B is formed by adding 4% silicone suds suppresser (DOW CORNING® 2-3000 ANTIFOAM) to the Comparative Composition 1.

Comparative Composition 1 has an initial suds height of 10.8 cm. According to the sudsing profile reduction test, Composition A has an initial sudsing profile reduction of 13%, while Composition B has an initial sudsing profile reduction of 20%, relative to Comparative Composition 1. Furthermore, after 5 additions of 2 mL of soil, containing a mixture of gravy, oil, cream, potato, minced beef, etc., Composition A has a sudsing profile reduction of 13%, while Composition B has a sudsing profile reduction of 25%. After 8 additions of 2 mL of soil, these sudsing profile reductions increased to 23% and 43%, respectively. During use, both Composition A and B provide a rinse water reduction of over 10%, relative to Comparative Composition 1.

What is claimed is:

1. A hand dishwashing composition comprising:
A. from about 0.1% to about 90%, by weight of a sudsing surfactant selected from the group consisting of an anionic surfactant, a nonionic surfactant, an amphoteric surfactant, and a mixture thereof;
B. an effective amount of a suds suppresser; and
C. the balance adjunct ingredients.

2. The hand dishwashing composition of claim 1, wherein the suds suppresser is selected from the group consisting of a silicone suds suppresser, a fatty acid suds suppresser, and a mixture thereof.

3. The hand dishwashing composition of claim 1, wherein the composition is substantially free of a suds booster.

4. The hand dishwashing composition of claim 1, wherein the composition has a pH of at least 6.

5. The hand dishwashing composition of claim 1, wherein the sudsing surfactant is an anionic surfactant having a carbon chain having an average percentage of branching of greater than 30%.

6. The hand washing composition of claim 1, further comprising an initial sudsing profile reduction of at least 10%.

7. The hand dishwashing composition of claim 1, wherein the suds suppresser is present at a level of up to about 10%, by weight.

8. A method for reducing the amount of water used in the rinsing step of a hand dishwashing process, comprising the steps of:
A. providing the hand dishwashing composition of claim 1;
B. applying the hand dishwashing composition to a dish and washware, wherein after the application step, the dish and washware comprise suds thereupon; and
C. rinsing the suds from the dish and washware with water.

9. The method of claim 8, further comprising a rinse water reduction of at least about 10%, as measured by the rinse water reduction test.

10. The method of claim 9, wherein the rinse water reduction is at least about 25%, as measured by the rinse water reduction test.
